(19) United States
(12) Patent Application Publication
(10) Pub. No.: US 2015/0170269 A1
(43) Pub. Date: Jun. 18, 2015

(54) REAL ESTATE MARKET CONDITION INDICATOR

(71) Applicant: CoreLogic Solutions, LLC, Irvine, CA (US)

(72) Inventors: Michael G. Bradley, Bethesda, MD (US); Wei Liu, Southlake, TX (US)

(21) Appl. No.: 14/316,449

(22) Filed: Jun. 26, 2014

Related U.S. Application Data
(60) Provisional application No. 61/917,559, filed on Dec. 18, 2013.

(51) Int. Cl. G06Q 40/02; G06Q 50/16

(52) U.S. Cl. CPC G06Q 40/025; G06Q 50/16

(57) ABSTRACT

A computer model for comparing an index with its long-term equilibrium value is generated by analyzing historical data, including macroeconomic data, and home price index data associated with real estate properties. The model is used to generate a measure of market condition that may represent the likelihood that a real estate property is located in an overvalued or an undervalued market. The measure of market condition may, for example, be used by a mortgage lender or servicer to correct credit criteria for accepting loan requests.

### PRIORITY CLAIM

The present application claims the benefit of U.S. Provisional Appl. No. 61/917,559, filed Dec. 18, 2013, the disclosure of which is hereby incorporated by reference.

### TECHNICAL FIELD

The present disclosure relates to data processing methods for derivation of a measure of market condition and using that measure in credit analyses.

### BACKGROUND

Many stakeholders have an interest in the health of real estate markets. These stakeholders include individual property owners, mortgage lenders, mortgage servicers, ratings agencies, counties reliant upon property tax revenue tied to real estate property values, investors in asset classes such as residential mortgage-backed securities, building developers, and lawmakers who wish to understand the impact of housing-related policies on overall economic health.

Real estate property stakeholders have long tried to assess the value and riskiness of individual properties and pools of properties. For example, financial institutions use the estimated value of the real estate property as one of the key factors in approving loan applications secured by the property. The CoreLogic and Case-Shiller Home Price Indexes (HPI) are the two leading measures of U.S. residential real estate prices, tracking changes in the value of residential real estate both nationally and in a set of defined geographic markets. In particular, the indices measure changes in housing market prices given a constant level of quality. Additionally, Capozza, Hendershott, and Mack [2004] in “An Anatomy of Price Dynamics in Illiquid Markets: Analysis and Evidence from Local Housing Markets,” Real Estate Economics, Vol. 32, pp. 1-32, developed a two-stage error correction structural model for forecasting future house values.

Changes in the property value over time can expose the financial institutions to loan losses and subsequent adjustments to loss reserves and profitability. Stakeholders share a common need to understand the likely future movement of real estate property values so they can make optimal business decisions.

### SUMMARY

In one embodiment, a computer model for comparing an index with its long-term equilibrium value of home prices is generated by analyzing historical data, including macroeconomic data, and home price index data associated with real estate properties. The model is used to generate a measure of market condition. The measure of market condition may, for example, be used by a mortgage lender or servicer to establish credit criteria for accepting loan requests.

Neither this summary nor the following detailed description purports to define the invention. The invention is defined by the claims.

### BRIEF DESCRIPTION OF THE DRAWINGS

FIG. 1 illustrates components of a computer-based system that generates a measure of market condition representing the state of a market in which a property is located within a defined period of time.

FIG. 2 illustrates a process that may be used by the system of FIG. 1 to generate a measure of market condition.

FIG. 3 illustrates an automated process that may be implemented by the system of FIG. 1 to adjust financial evaluation criteria (e.g. credit criteria) based at least partly on the generated measure of market condition.

FIG. 4 illustrates a loan acceptance matrix that may be modified according to generated measure of market condition.

FIG. 5 illustrates an embodiment of a financial evaluation criteria adjuster that can include credit criteria adjuster module.

### DETAILED DESCRIPTION OF SPECIFIC EMBODIMENTS

Specific, non-limiting embodiments will now be described with reference to the drawings. Nothing in this description is intended to imply that any particular feature, component or step is essential. The inventive subject matter is defined by the claims.

Asset evaluation is one of the important factors in many of the decisions made in real estate and credit markets. For instance, changes in real estate property values over time expose financial institutions to variability in their loan losses and subsequent adjustments to loss reserves and profitability. In particular, prices may not accurately reflect the fundamental value of an asset. For example, real estate assets (e.g., homes) may be located in overvalued or undervalued markets. Many credit decisions such as granting loans to purchase real estate properties depend on the price of the home. Accordingly, a process for modifying credit criteria is needed to determine a more accurate value of an asset in a particular market at a particular time of interest. The time of interest may be past, present or in the future.

This disclosure describes embodiments of systems and methods that can derive a measure of market conditions to estimate the value of a property in a particular market. Knowing the measure of market condition can help the stakeholders to consider current and long-term house price trends. Further, the stakeholders can determine the likelihood that housing prices in a local market will move in a certain direction and affect the expected return from holding a particular property or portfolio of properties.

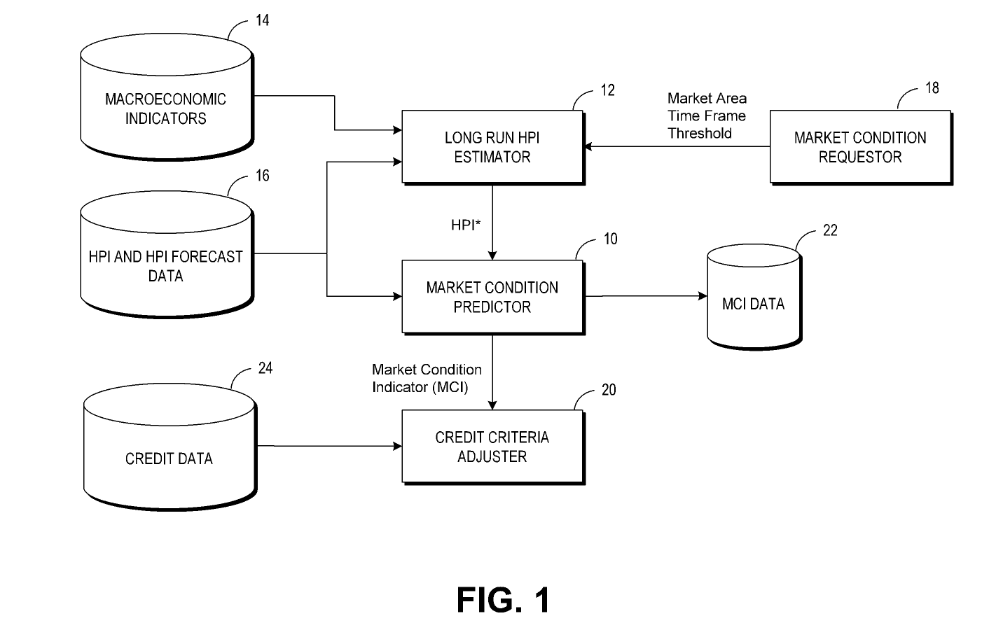

FIG. 1 illustrates the functional components of a computer-based system for determining a measure of market condition for a property of interest according to one embodiment. The market represents a geographic region where the property of interest is located. The geographic regions can be determined according to census divisions or other predetermined metrics. For example, each region may correspond to a Core Based Statistical Area (CBSA), which is a U.S. geography area defined by the Office of Management and Budget. Another example is a Metropolitan Statistical Area (MSA), which is a geographical region with a relatively high population density at its core and close economic ties throughout the area. The measure of market condition can indicate a state of real estate values in a particular geographic area depending on the chosen metric. The market condition measure may also show the likelihood that the housing prices in a particular market will change and in which direction.

In some embodiments, the measure of market condition is an indicator that represents a comparison of a long-run equilibrium index of the market with the observed or forecasted index of the market. The system includes a market condition predictor component 10 that can compare and derive the indicator of market condition. For example, in the housing market, the market condition predictor 10 can use the CoreLogic or Case-Shiller Home Price Indexes (HPI) or any other index or measure associated with home prices or house price trend for the comparison.

The market condition predictor 10 can obtain the HPI values for a particular market from the HPI data repository 16. The HPI values may be maintained and updated by vendors such as CoreLogic, Inc. in the HPI data repository 16. In some instances, the market condition predictor 10 can update HPI values to most recent data before using them to calculate the market condition indicator. As discussed above, the indicators can be a function of the comparison between an index at a particular time and the long-run equilibrium value. In the real estate home prices example, the predictor 10 can compare the HPI from a particular time or time period to the long-run equilibrium HPI value.

The system can include a long-run HPI estimator module 12 to determine the equilibrium HPI based, at least in part, on macroeconomic drivers. The equilibrium HPI may also be a function of historical trends in the macroeconomic drivers. The drivers can include economic indicators such as disposable income, the unemployment rate, etc. The exact relationship between HPI and the macroeconomic drivers may vary between different markets (e.g., different geographical regions). Accordingly, each market may have one or more models to calculate long-run equilibrium values for HPI based on the macroeconomic drivers. The long-run HPI estimator 12 can retrieve the macroeconomic data from macroeconomic indicators data repository 14. The repository 14 may be maintained by vendors such as IHS Global Insight. In some embodiments, the long-run HPI estimator 12 can retrieve the data directly from census data repositories. The market condition predictor 10 can then compare the long-run equilibrium HPI value with the HPI value from a particular time and market obtained from repository 16 and generate a measure or indication of the market condition (MCI), as described more in detail below. The predictor 10 can store the calculated measures or indicators in the MCI data repository 22.

The indicator or measure generated by the system can be used in various ways. A lender or mortgage servicer can use the indicator to modify credit parameters used in approving loans. For example, if the indicator shows that the market where the property is located is overvalued, the credit adjuster 20 can automatically increase the required FICO score for the borrower. In other embodiments, the credit adjuster may change the required down payment or the LTV (loan to value) threshold. Accordingly, creditors can make improved financial decisions based on the market condition indicators generated by the market condition predictor 10.

In some embodiments, the market condition indicator is generated in response to a request from a market condition requestor 18. The request can include parameters such as the location of the property or the market, the time frame of interest, and a threshold value. In some embodiments, the market condition predictor 10 can automatically identify a market area based on the location of the property. The market condition predictor 10 can use the threshold value in generating a market indicator. For example, in some embodiments, the market condition predictor 10 generates an indicator of overvalued or undervalued if the difference in comparison between HPI and the equilibrium HPI exceeds the threshold value (e.g., 10%); otherwise the indicator can correspond to neutral. In other embodiments, the thresholds values may be different, e.g., 5%, 15%, 20%, or any numeric value suitable for a particular application. Furthermore, in some embodiments, the credit criteria adjuster 20 and/or the market condition requestor 18 are components of lender systems (not shown). Accordingly, lender systems (e.g., financial institutions) can request a market condition indicator when needed. The threshold criteria can be a function of risk tolerance or other models of the lender.

The system shown in FIG. 1 may be implemented by a computer system that comprises one or more physical computers or computing devices, which may but need not be co-located. Different components of the computer system may, in some cases, be operated or controlled by different entities. The computer system may be programmed with program code modules that are stored on one or more non-transitory computer storage devices (hard disk drives, solid state memory devices, etc.) for performing the functions described above and in further detail below. Some or all of the functions may alternatively be implemented in application-specific circuitry (ASICs, FPGAs, etc.) of the computer system. The illustrated data repositories 14, 16, 22, and 24 may be implemented as one or more databases, flat file systems, or other types of data storage systems that use non-transitory computer storage devices to persistently store data.

Although not shown in FIG. 1, the system may include a user interface component that enables lenders, mortgage servicers, and/or other classes of users to request and obtain market condition indicators for specific properties. For example, the system may host a web-based or other interactive user interface and service that enables a user to specify a particular property (e.g., by property address, parcel number, mortgage loan number or other identifier) or to upload a list of properties. The system may then generate and return a web page, spreadsheet, or other document containing the corresponding measures of market conditions for the respective properties. As explained below, the system may also enable the user to perform a higher level analysis on properties.

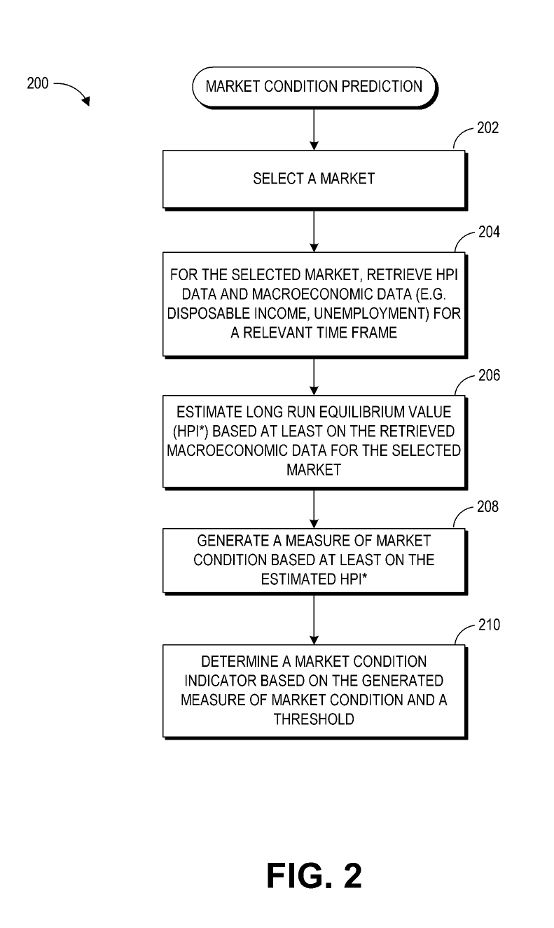

FIG. 2 illustrates a process 200 that may be implemented by the market condition predictor 10 and/or the long-run HPI estimator 12 modules of FIG. 1 to generate a measure of market condition. This process may be re-executed periodically (e.g., weekly, monthly or yearly) to incorporate new data.

In block 202, the process identifies the market based on the geographic location of the property of interest. The geographic location of the property of interest can be received as an input from the market condition requestor 18 of FIG. 1. Based on the geographic location of the property, the long-run HPI estimator 12 and/or the market condition predictor 10 can look up the corresponding market. As discussed above, markets can be predetermined (e.g., according to CBSA or MSA) or customized. The look up tables for identifying a market associated with a specific property may be stored in one of the data repositories or implemented in the components of the system. In certain embodiments, it is advantageous to use predetermined markets because the corresponding macroeconomic data and HPI data may be easily available for these markets.

In block 204, the process can obtain data (e.g., macroeconomic data, HPI, etc.) associated with the selected market. For example, for a property located in Sacramento, Calif., the retrieved data may correspond to CBSA 40900. The macroeconomic data can include, for example, unemployment rate, housing starts, disposable income, population, personal consumption expenditure, new one-family homes sold, new one-family homes for sale, 30-year Freddie Conventional Mortgage Rate, rental vacancy rate, and residential construction index for this geography. The macroeconomic data can be retrieved by the long-run HPI estimator 12 from the macroeconomic indicators data repository 14 for the selected market for a particular time of interest. The long-run HPI estimator 12 can also retrieve HPI data at block 204 for the selected market for a particular time of interest. The HPI indices may be retrieved from the HPI data repository 16. As an example, in January of 2005, the following HPI and macroeconomic data was available for the 40900 CBSA market that includes properties located in Sacramento.

HPI=237.1

Unemployment rate=5.1%

Housing starts=17,740

Disposable Income=$65,635

Real Disposal Income per capita=40,878

In block 206, the process estimates the long-run equilibrium value (HPI*) for a market at a time of interest based, at least partly, on the retrieved macroeconomic data from the selected market. The equilibrium value can be calculated by the long-run HPI estimator 12 of FIG. 1. The estimator 12 may include a model for calculating HPI*. In one embodiment, the estimator 12 uses a two-stage error correction structural model developed by Capozza, Hendershott, and Mack [2004] in “An Anatomy of Price Dynamics in Illiquid Markets: Analysis and Evidence from Local Housing Markets,” Real Estate Economics, Vol. 32, pp. 1-32, incorporated herein by reference in its entirety. The model takes into account historical relationship between HPI and the macroeconomic drivers. The relationship between HPI* and the macroeconomic drivers may vary by market. For the 40900 CBSA market example, the calculated HPI* value is 185.8 using the two stage error correction structural model for the example retrieved data (sample numeric calculation shown below).

$$\begin{matrix}ln ( real {HPI}^{*} ) = - 1.0942 + {1.76556}^{*} ln \\ ( real disposal income per capita / 1000 ) \\ = - 1.0942 + {1.76556}^{*} ln ( 40878 / 1000 ) \\ = 5.45707\end{matrix}$$

$$\begin{matrix}Real {HPI}^{*} = exp ( 5.45707 ) \\ = 234.4\end{matrix}$$

$$\begin{matrix}{HPI}^{*} = real {HPI}^{*} \times Personal Consumption Expenditure ratio \\ = 234.4 \times 0.79 \\ = 185.8\end{matrix}$$

In block 208, the process generates a measure of market condition based at least on the estimated HPI*. In one embodiment, the market condition predictor 10 compares the HPI* with the HPI value to generate the measure of market condition. In the above example, the predictor 10 can compare the HPI* of 185.8 to HPI of 237.1 for January of 1995 for Sacramento. In this case, the equilibrium value is lower than the HPI of Sacramento in January of 1995. The estimator 10 can calculate the difference in percentage between HPI and HPI* as shown below:

$$\begin{matrix}Market Condition Measure ( MCM ) = ( HPI - {HPI}^{*} ) / {HPI}^{*} \times 100 \% \\ = ( 237.1 - 185.8 ) / 185.8 \times 100 \% \\ = 28 \%\end{matrix}$$

The measure of the market condition can be the percentage difference calculated above, or can be another measure of this difference. In some embodiments, the process can further determine a market condition indicator at block 210 based on the above comparison between HPI and HPI*. For example, the market condition predictor 10 can use the difference between HPI and HPI* and compare it with a threshold value. As discussed above, the threshold value may be received from market condition requestor 18. The threshold value may also be predetermined and stored in the system of FIG. 1. In an embodiment, the threshold value is 10%. In other embodiments, other threshold ranges e.g., 5%, 15%, or 20% may be used or the system may simply return a continuous number. The market condition predictor can determine whether the percentage difference between HPI and HPI* is greater than 10% to select an indicator. In one embodiment, there are three possible indicators of market condition: “overvalued”, “undervalued”, or “neutral.” The predictor 10 can use the following criteria to select the indicator:

| Condition | Indicator |
|---|---|
| MCM is positive and has a value | “overvalued” |
| greater than the threshold value (e.g. | |
| 10%) | |
| MCM is negative and has a value | “undervalued” |
| greater than the threshold value | |
| otherwise | “neutral” |

An overvalued market indicates that the index (e.g., HPI) is higher than the long-term equilibrium value (HPI*), which means that prices will likely go down as macroeconomic drivers tend to drive the market towards equilibrium. In an undervalued market, the index is lower than the long-term equilibrium value, which may be an indication that prices are likely to go up. In some embodiments, using an indicator (e.g., “overvalued” or “undervalued”) may be easier for a user to readily identify the state of the market and where it is going. The market condition predictor 10 may also use other identifiers for the indicators. For example, instead of overvalued or undervalued, the predictor 10 may select “+” or “−” signs. The system may also show the indicators in different colors.

The process can also determine measure of market conditions in the future based on forecast data retrieved from the data repositories 14 and 16. The following example shows an example numerical calculation for a forecasted market condition indicator. The property is again located in Sacramento and accordingly the CBSA code is 40900. The time of interest is January, 2018 and the threshold value is 10%. Using the example market and the time of interest, the long-run HPI estimator 12 and the market condition predictor 10 can retrieve the following values from the repositories 14 and 16:

| | |
|---|---|
| HPI | 299.2 |
| Unemployment rate | 6.1% |
| Housing starts | 14,059 |
| Disposable Income | 112,822 |

The long-run HPI estimator 12 can use the two stage error correction model to estimate the equilibrium index. For the example data above, the estimated equilibrium value, HPI* is 308.4. Subsequently, the market condition predictor 10 can calculate the measure of market condition as shown below:

$$\begin{matrix}Market Condition Measure ( MCM ) = ( HPI - {HPI}^{*} ) / {HPI}^{*} \times 100 \% \\ = ( 299.2 - 308.4 ) / 308.4 \times 100 \% \\ = - 3 \%\end{matrix}$$

The negative value of MCM indicates that the market may be undervalued. However, in this example, the threshold value is 10%. Since the absolute value of MCM is less than 10%, the market condition predictor can select the “neutral” identifier for the indicator.

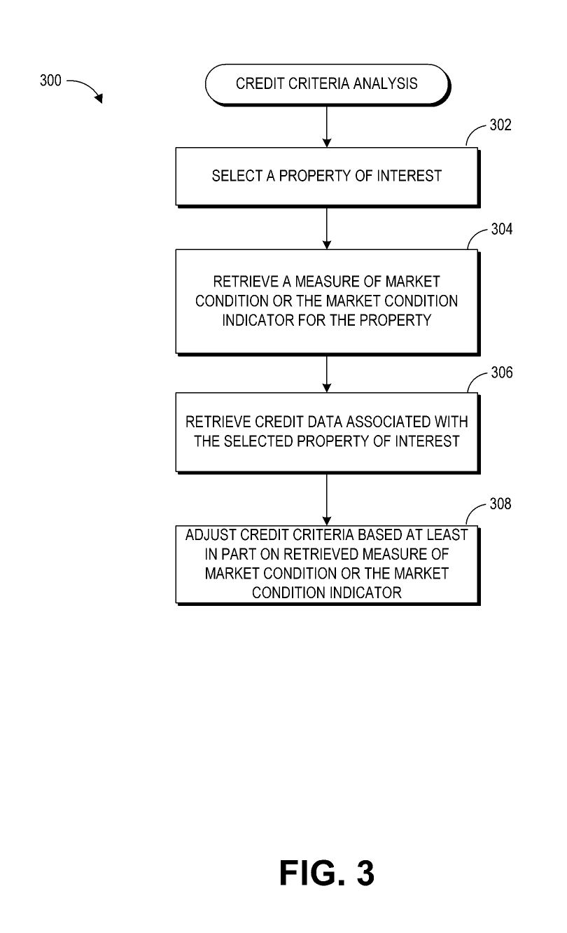

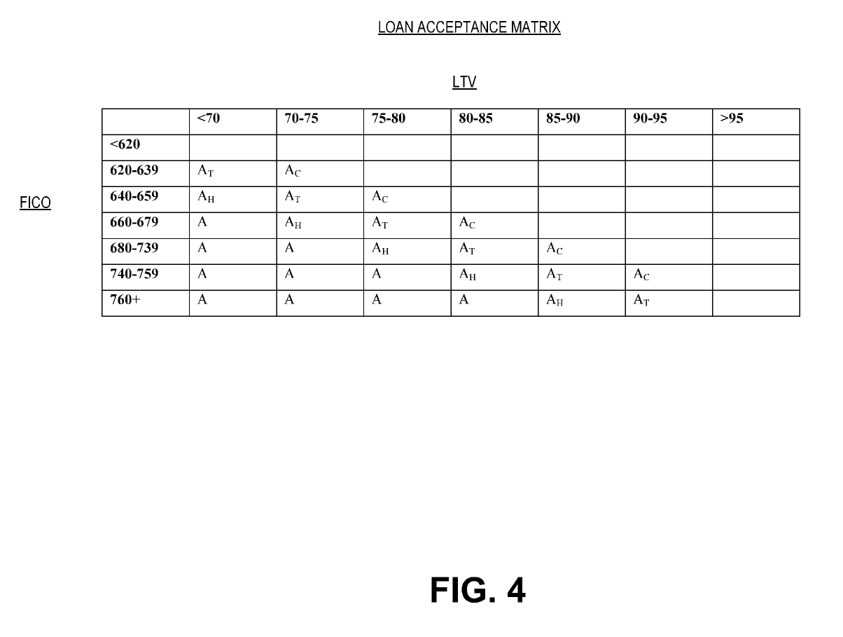

FIG. 3 illustrates the process 300 implemented by the credit criteria adjuster 20 to adjust credit criteria based on the calculated measure of market condition. As discussed above, real estate property stakeholders have long tried to assess the value and riskiness of individual properties or pools of properties. For example, financial institutions use estimated property value as one of the key factors in approving loan applications secured by the property. Relying on the soundness of the estimate, financial institutions accept the risk of lending large sums of money and attach the property as security for the transaction. Accordingly, the accuracy of estimated value of the property and the potential movements of property value are critical. The measure of market condition can be used by many stakeholders. For example, the measure of market condition can be used by lenders to adjust loan criteria as discussed more in detail with respect to FIG. 4.

In block 302, the process 300 selects a property of interest. For example, the selection of property might be based on an input from a user interface. In some embodiments, the input is received from third party systems (e.g., lender systems). In block 304, the process 300 may retrieve a measure of market condition or the market condition indicator for the selected property. As discussed above with respect to FIG. 2, the market condition measure or the indicator determination can be implemented by the long-run HPI estimator 12 and/or the market condition predictor 10.

In block 306, the process retrieves the credit data associated with the selected property of interest. For example, in the case where a borrower is seeking a loan for the property of interest, the associated data may include loan amount, value of property, FICO score of the borrower, down payment required, etc. The associated data may be stored in a credit data repository 24 as shown in FIG. 1.

In block 308, the process adjusts the credit criteria based on the retrieved credit data and the measure of market condition or the market condition indicator. For example, the credit criteria adjuster 20 can receive an indication from the market condition predictor 10 that the property of interest is in an overvalued market. Accordingly, the credit criteria adjuster 20 can change some of the credit parameters (e.g., down payment required for a loan) to account for the overvalued market. The credit criteria adjuster 20 can also change the required LTV (loan to value) ratio and/or FICO scores as described more in detail below. In some embodiments, the credit data repository 24 and the credit criteria adjuster 20 are part of lender systems (not shown).

FIG. 4 illustrates an example loan acceptance matrix that lenders can use to evaluate whether to grant or deny loans. In the illustrated example, the loan acceptance matrix maps FICO scores of borrowers versus the loan-to-value (LTV) ratio for a property. For example, if the value of property is $100,000 and the loan amount is $50,000, the LTV is 0.5. Lenders typically have some predetermined criteria for evaluating borrowers. For a borrower with a FICO score in the range of 660-679, the lenders may have set 75-80 as the maximum LTV ratio. However, this may lead to an inaccurate assessment in cases where the market is overvalued or undervalued. For an overvalued market, the value of the property may be higher than the equilibrium value and may go down. This may lead to financial institutions making inaccurate assessments. To correct for market conditions, the financial institutions can request a measure of market condition or indicator as described above. In some embodiments, the financial institutions may generate their own indicators based on measure of market condition. Based on the received market indicator, the credit criteria adjuster can automatically adjust the credit criteria such as the loan acceptance matrix. For the same FICO score range of 660-679, in an overvalued market, the credit adjuster 20 can change the LTV value from 75-80 (A_{T}) to 70-75 (A_{H}). In the alternative, for a fixed LTV value of 80-85, the credit criteria adjuster 20 can increase the required FICO score from 680-739 to 740-759. For an undervalued market, the credit adjuster 20 can decrease the required FICO score to 660-679 (A_{c}) for the LTV value of 80-85. In the illustrated matrix, A_{T} represents neutral market, A_{C} represents the changed values for an undervalued market, and A_{H} represents the changed values the overvalued markets. The credit criteria adjuster 20 can change the Loan Acceptance Matrix according to the calculated measure of market conditions.

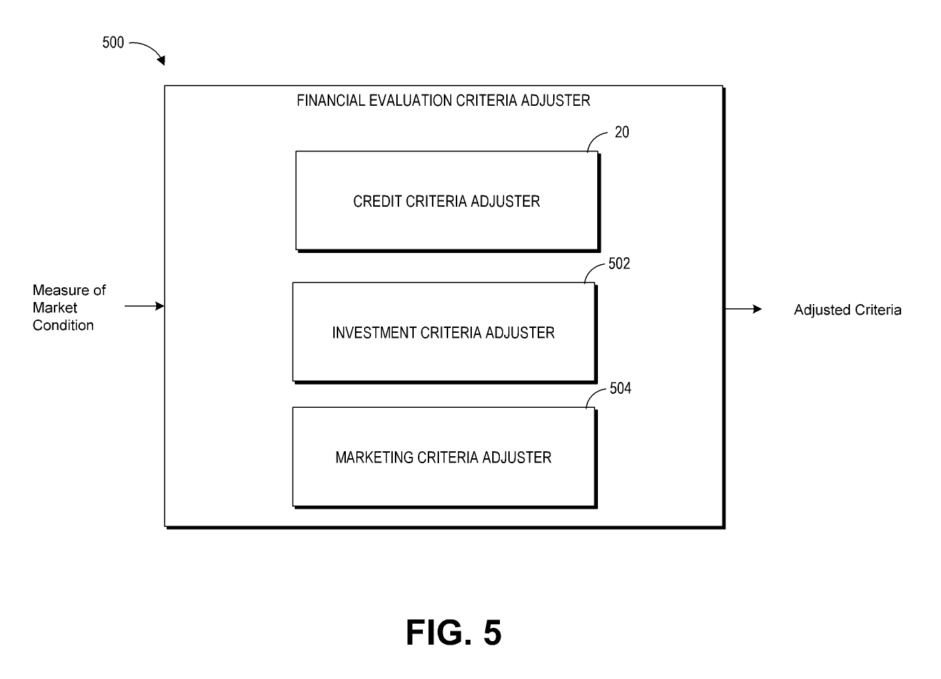

As discussed above, the measure of market condition can be used to adjust credit criteria. It should be noted that credit criteria is just one aspect of overall financial evaluation criteria. Any of the features described herein can also be implemented in other systems including investment systems, marketing systems, rental property systems, etc. FIG. 5 illustrates an embodiment of financial evaluation criteria adjuster 500 that can be implemented with the systems and methods described above to adjust a financial decision parameter. For instance, the financial evaluation criteria adjuster 500 can include a credit criteria adjuster 20 that can change credit criteria based on a measure of market condition as discussed above with respect to FIGS. 1 to 4. In some embodiments, the financial evaluation criteria adjuster 500 can also include investment criteria adjuster 502 and/or marketing criteria adjuster 504. The investment criteria adjuster 502 can use the measure of market condition to adjust criteria for investment decisions. Investors who may be interested in purchasing distressed properties may need to evaluate the capitalization rate based in part on evaluating the house prices in the future. Whether a market is overvalued or undervalued can have significant impact on the capitalization rate, which may affect the desirability of investing in a specific market. Accordingly, the measure of market condition can be used to select a market for investment. The measure of market condition can also be used to adjust a financial institution's loan loss reserves. Additionally, the marketing criteria adjuster 504 can use the measure of market condition to identify potential markets for mortgage origination.

All of the processes and process steps described above (including those of FIGS. 2-3) may be embodied in, and fully automated via, software code modules executed by one or more general purpose computers or computing devices. The code modules may be stored in any type of non-transitory computer-readable medium or other computer storage or storage device. As mentioned above, some or all of the methods or steps may alternatively be embodied in specialized computer hardware. The results of the disclosed methods and tasks may be persistently stored by transforming physical storage devices, such as solid state memory chips and/or magnetic disks, into a different state.

Thus, all of the methods and tasks described herein may be performed and fully automated by a programmed or specially configured computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other computer-readable storage medium.

The foregoing description is intended to illustrate, and not limit, the inventive subject matter. The scope of protection is defined by the claims. In the following claims, any reference characters are provided for convenience of description only, and not to imply that the associated steps must be performed in a particular order.

What is claimed is:

1. A system, comprising:
a first data repository that stores macroeconomic data for each of a plurality of markets;
a second data repository that stores home price index data for each of the plurality of markets; and
a computer system comprising one or more computing devices, the computer system programmed to generate, for a specific real estate property, a measure of market condition using the macroeconomic data and the home price index data for a selected market and a time of interest, wherein the selected market is based at least partly on the geographical location of the specific real estate property, said measure of market condition representing a likelihood that a value of the specific real estate property will change;
said computer system further comprising a financial evaluation criteria adjuster component that automatically adjusts financial evaluation criteria based on the measure of market condition;
wherein the computer system is programmed to generate the measure of the market using a model that compares equilibrium value of the home price index with the home price index at the time of interest, said equilibrium value of the home price index depending on the macroeconomic data for the selected market.

2. The system of claim 1, wherein the financial evaluation criteria includes credit criteria.

3. The system of claim 2, wherein the credit criteria includes a FICO score threshold of a borrower associated with the specific real estate property.

4. The system of claim 2, wherein the credit criteria includes a loan to value ratio for the specific real estate property.

5. The system of claim 1, wherein the measure of market condition comprises a numerical value representing a difference between the equilibrium value of the home price index and the home price index at the time of interest.

6. The system of claim 1, wherein the measure of market condition comprises an indicator, said indicator determined by the computer system by comparing a difference between the equilibrium value of the home price index and the home price index at the time of interest to a threshold value.

7. The system of claim 1, wherein the equilibrium value of the home price index is calculated using a two stage error correction model.

8. The system of claim 1, further comprising a component that automatically determines whether to accept a loan request using the measure of market condition.

9. The system of claim 1, wherein the macroeconomic data comprises one or more of the following: unemployment rate, housing starts, and disposable income.

10. A computer implemented method, comprising:
retrieving macroeconomic data for a selected market associated with a geographical location at a time of interest;
retrieving house price index data for the selected market associated with the geographical location at the time of interest; and
generating a measure of market condition at least partly by comparing an equilibrium value of the home price index with the home price index at the time of interest for the selected market, said measure of market condition representing a likelihood that a value of a real estate property in the selected market does not match a price of the real estate property in the selected market, said equilibrium value of the home price index depending on the macroeconomic data for the selected market;
said method performed programmatically by a computer system that comprises one or more computing devices.

11. The computer implemented method of claim 10, further comprising adjusting credit criteria based on the measure of market condition.

12. The computer implemented method of claim 11, wherein the credit criteria includes a credit score threshold of a borrower associated with the specific real estate property.

13. The computer implemented method of claim 11, wherein the credit criteria includes a loan to value ratio for the specific real estate property.

14. The computer implemented method of claim 10, wherein the measure of market condition comprises a numerical value representing a difference between the equilibrium value of the home price index and the home price index at the time of interest.

15. The computer implemented method of claim 10, wherein the measure of market condition comprises an indicator, said indicator determined by the computer system by comparing a difference between the equilibrium value of the home price index and the home price index at the time of interest to a threshold value.

16. The computer implemented method of claim 10, wherein the equilibrium value of the home price index is calculated using a two stage error correction model.

17. The computer implemented method of claim 10, further comprising automatically determining whether to accept a loan request using the measure of measure of market condition.

18. The computer implemented method of claim 10, wherein the macroeconomic data comprises one or more of the following: unemployment rate, housing starts, and disposable income.

19. A system, comprising:
a data repository that stores loan-related attributes for a real estate property including attributes associated with a borrower;
a data repository that stores threshold values for accepting loan requests; and
a computer system comprising one or more computing devices, the computer system programmed to use a measure of market condition to adjust said threshold values for accepting loan requests and compare loan-related attributes for the real estate property with the adjusted threshold values to automatically determine whether to accept a loan request for the real estate property,
wherein said measure of market condition is generated using a model that compares equilibrium value of a home price index with a home price index at a time of interest for a selected market, said selected market is based at least partly on the geographical location of the real estate property.

20. The system of claim 19, wherein the loan-related attributes comprise one or more of the following: price of the real estate property, credit score of a borrower, and loan amount, updated loan-to-value ratio.
